(19) United States
(12) Patent Application Publication
(10) Pub. No.: US 2013/0096215 A1
(43) Pub. Date: Apr. 18, 2013

(54) Hydrophobic Onium Salt Addition to Fuel Cell Electrode Inks for Improved Manufacturability

(71) Applicants: Roland J. Koestner, Penfield, NY (US); Heidi M. Viterise, Rochester, NY (US); Irina Kozhinova, Penfield, NY (US)

(72) Inventors: Roland J. Koestner, Penfield, NY (US); Heidi M. Viterise, Rochester, NY (US); Irina Kozhinova, Penfield, NY (US)

(73) Assignee: GM GLOBAL TECHNOLOGY OPERATIONS LLC, Detroit, MI (US)

(21) Appl. No.: 13/275,795

(22) Filed: Oct. 18, 2011

(51) Int. Cl. C09D 11/10

(52) U.S. Cl. 521/28

(57) ABSTRACT

An ink composition for forming fuel cell electrodes includes a solvent system, an ion-conducting polymer dispersed within the solvent system, a supported catalyst dispersed within the solvent system; and an onium compound having a hydrophobic hydrocarbon moiety. The onium compound is substantially soluble in the solvent system.

### FIELD OF THE INVENTION

In at least one aspect, the present invention relates to ion exchange membranes for fuel cells.

### BACKGROUND OF THE INVENTION

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode while also serving as an electrical insulator.

In proton exchange membrane type fuel cells, hydrogen is supplied to the anode as fuel, and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Typically, the ion conductive polymer membrane includes a perfluorosulfonic acid (PFSA) ionomer.

Each catalyst layer has finely divided catalyst particles (for example, platinum particles), supported on carbon particles, to promote oxidation of hydrogen at the anode, and reduction of oxygen at the cathode. Protons flow from the anode through the ion conductive polymer membrane to the cathode where they combine with oxygen to form water which is discharged from the cell.

The MEA is sandwiched between a pair of porous gas diffusion layers (“GDL”), which in turn are sandwiched between a pair of electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells in stacks in order to provide high levels of electrical power.

In many fuel cell applications, electrode layers are formed from ink compositions that include a precious metal and a perfluorosulfonic acid polymer (PFSA). For example, PFSA is typically added to the Pt/C catalyst ink in electrode layer fabrication of proton exchange membrane fuel cells to provide proton conduction to the dispersed Pt nanoparticle catalyst as well as binding of the porous carbon network. Commercial Nafion® polymer is widely used in this application and has a random co-polymer structure where a typical equivalent weight of 950 g/mol gives a sulfonic acid monomer fraction at 16.5% mol/mol. Electrode layer cracks develop during drying of the applied ink film and directly impact the durability of the fabricated membrane-electrode assembly (MEA) during fuel cell operation.

Accordingly, there is a need for improved ink composition for forming fuel cell electrodes.

### SUMMARY OF THE INVENTION

In at least one embodiment, the present invention solves one or more problems of the prior art by providing an ink composition for forming a fuel cell layer. The ink composition includes a solvent system comprising water and an alcohol, an ion-conducting polymer dispersed within the solvent system, a supported catalyst dispersed within the solvent system; and an onium compound having a hydrophobic hydrocarbon moiety. The onium compound is substantially soluble in the solvent system.

In another embodiment, an ink composition for forming a fuel cell layer is provided. The ink composition includes a solvent system; an ion-conducting polymer dispersed within the solvent system; a supported catalyst dispersed within the solvent system; and a primary ammonium compound including a hydrophobic hydrocarbon moiety selected from the group consisting of C₅-C₃₀ alkyl, C₅-C₃₀ alkenyl, and C₆-C₃₀ aryl.

In another embodiment, a method for making a catalyst layer for a fuel cell using the ink compositions is provided. The method includes a step of combining a first liquid composition with an onium compound to form a second liquid composition. The first liquid composition includes a solvent system, a supported catalyst, and an ion-conducting polymer while the onium compound includes a hydrophobic hydrocarbon moiety. The catalyst layer is formed from the second liquid composition.

It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

FIG. 1 provides a schematic cross section of a fuel cell incorporating layers formed from inks of an embodiment of the invention;

FIG. 2 provides plots of the calculated log P and log(water solubility) for a homologous series of aliphatic amines with increasing carbon length;

FIG. 3 provides the chemical structure for a Nafion® polymer with z=1;

FIG. 4 provides CCDM PtCoHSC ink rheology after 1-day milling; high shear stress and hysteresis are only observed at the low OA addition levels (0 and 5% mol/mol Nafion® neutralization);

FIG. 5 provides CCD PtCoHSC ink rheology after 1-day milling and again after a 1-day hold;

FIG. 6 provides particle size distribution of the CCDM PtCoHSC ink after 1-day mill and again after 1-day hold;

FIG. 7 provides particle size distribution of the CCDM PtCoHSC ink after a 1-day mill and again after a 1-day hold;

FIG. 8 provides particle size distribution of the CCD PtCoHSC ink after 1-day mill and again after 1-day hold;

FIG. 9 provides reflected light micrographs of CCDM PtCoHSC electrodes. Left panel, 1-day mill; right panel, 1-day mill+1-day hold, a) 0% OA, b) 5% OA, c) 10% OA, and d) 25% OA;

FIG. 10 provides optical micrographs of CCD PtCoHSC electrodes. Left panel, reflected light; right panel, transmitted light, a) 0% OA after 1-day mill, b) 0% OA after 1-day mill and 1-day hold, c) 25% OA after 1-day mill, and d) 25% OA after 1-day mill and 1-day hold;

FIG. 11 provides beginning-of-life (BOL) voltage performance for CCDM PtCoHSC electrodes;

FIG. 12 provides beginning-of-life (BOL) voltage performance for CCD PtCoHSC electrodes;

FIG. 13 provides PtCoF ink rheology at 50% mol/mol amine neutralization in EtOH:H₂O:nPrOH::2:2:1 w/w solvent;

FIG. 14 provides calculated (solid) vs measured (dashed) suspension viscosity for carbon black in EtOH:H₂O:nPrOH::2:2:1 w/w solvent;

FIG. 15 provides carbon black suspension viscosity (mPa-s) vs solid loading (w/w % ink) in EtOH:H₂O:nPrOH::2:2:1 w/w solvent-a) carbon black only, b) carbon black+10 mM oleylamine+12 mM HNO₃ and c) carbon black+I(Nafion®/C=0.30 @ 50% mol/mol oleylamine neutralization;

FIG. 16 provides Zeta-potential for HOPG with increasing oleylamine (OA) solution concentration at pH(e)=3.5 vs 5.5 in EtOH:H2O::1:1 w/w solvent;

FIG. 17 provides Nafion® (D2020) adsorption on HOPG at 0 vs 50% mol/mol oleylamine neutralization in EtOH:H2O::1:1 w/w solvent at pH(e)=4.0-a) no OA addition and b) 50% OA neutralization; and

FIG. 18 provides SEM top-down images of the Pt-whisker electrode decal after Nafion® overcoat from EtOH:H₂O:nPrOH::2:2:1 w/w-a) bare Pt-whisker decal (no Nafion® overcoat), b) 0.25 nm aim polymer thickness without OA neutralization, c) 1.0 nm aim polymer thickness without OA neutralization, and d) 1.25 nm aim polymer thickness with 50% oleylamine neutralization.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

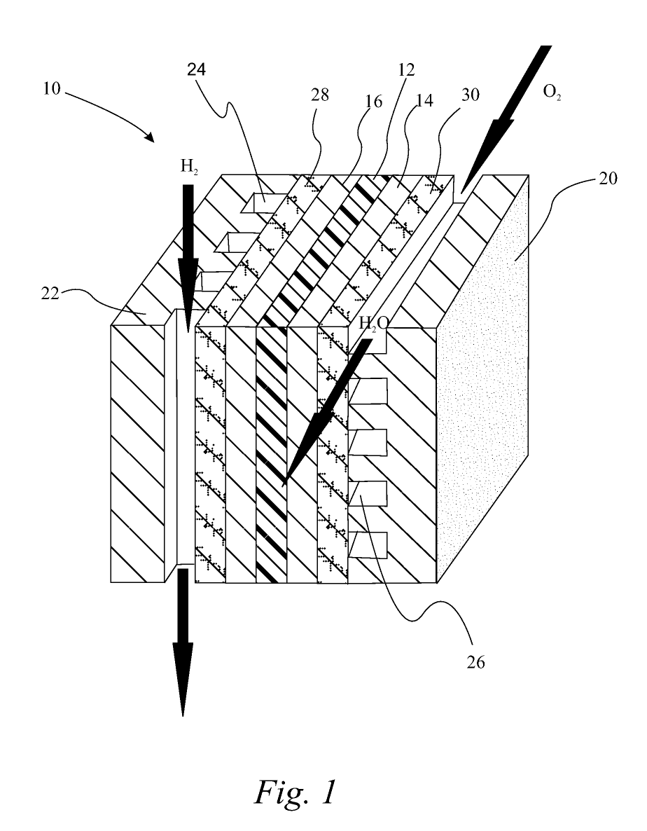

With reference to FIG. 1, a fuel cell that incorporates an electrode layer formed from the ink compositions set forth below is provided. PEM fuel cell 10 includes polymeric ion conductive membrane 12 disposed between cathode catalyst layer 14 and anode catalyst layer 16. Collectively, polymeric ion conductive membrane 12, cathode catalyst layer 14 and anode catalyst layer 16 are referred to as the membrane electrode assembly (MEA). Cathode catalyst layer 14 and anode catalyst layer 16 are advantageously formed from embodiments of a composition set forth below. Fuel cell 10 also includes conductive plates 20, 22, gas channels 24 and 26, and gas diffusion layers 28 and 30.

In an embodiment, an ink composition for forming a fuel cell layer is provided. The ink composition includes a solvent system, an ion-conducting polymer dispersed within the solvent system, a supported catalyst dispersed within the solvent system, and an onium compound having a hydrophobic hydrocarbon moiety. The onium compound and the ion-conducting polymer are substantially soluble in the solvent system. Moreover, the ink composition and solubility of the onium compound is such that the average particle size is less than about 1.5 microns in diameter.

As set forth above, the ink composition includes an ion-conducting polymer. Such ion-conducting polymers typically include protogenic groups such as —SO₂X, —PO₃H₂, —COX, and combinations thereof where X is —OH, a halogen, or an ester. Examples of suitable ion-conducting polymers include, but are not limited to, perfluorosulfonic acid polymers (PFSA), hydrocarbon based ionomers, sulfonated polyether ether ketone polymers, perfluorocyclobutane polymers, and combinations thereof. In a variation, the ion conducting polymer is present in an amount of 1 to 20 weight percent of the total weight of the ink composition. It should be appreciated that at least a portion of the protogenic groups are neutralized via formation of the onium compound. Commercial Nafion® polymer is a particularly useful example of an ion-conducting polymer.

The amount of onium compound is a feature of the present invention. In particular, the onium compound is present in a sufficient amount that at least a portion of the sulfonic acid groups in the ion-conducting polymer has been neutralized. In this context, it should be remembered that the onium compound is created by adding an amine (or similar Lewis base) to a composition including the PFSA, thereby resulting in neutralization and formation of the onium compound. In a refinement, the onium compound is present in an amount such that 5 mole % to 100 mole % of the protogenic groups in the ion-conducting polymer are neutralized. In a further refinement, the onium compound is present in an amount such that 10 mole % to 80 mole % of the protogenic groups in the ion-conducting polymer are neutralized. In still further refinement, the onium compound is present in an amount such that 10 mole % to 50 mole % of the protogenic groups in the ion-conducting polymer are neutralized. In still further refinement, the onium compound is present in an amount such that 10 mole % to 30 mole % of the protogenic groups in the ion-conducting polymer are neutralized. In another variation, the onium compound is present in an amount of 0.02 to 5 weight percent of the total weight the composition. In a refinement, the onium compound is present in an amount of 0.1 to 2 weight percent of the total weight of the ink composition.

In a refinement, the onium compound is selected from the group consisting of primary ammonium cations, primary phosphonium cations, and combinations thereof. In still another refinement, the onium compound includes primary ammonium cations. In a refinement, the hydrophobic hydrocarbon moiety is selected from the group consisting of C₅-C₃₀ alkyl, C₅-C₃₀ alkenyl, and C₆-C₃₀ aryl. Examples of useful amines for forming the onium compound include, but are not limited to primary amines such as dodecylamine and oleylamine, secondary amines such as di(n-butyl)amine and didecylamine, tertiary amines such as tri(n-butyl)amine and methyldidecylamine, and quaternary amines such as tetra(n-butyl)ammonium hydroxide.

As set forth above, the ink composition also includes a dispersed catalyst. In a refinement, the Pt or Pt-alloy catalyst is present in an amount of 1 to 10 weight percent of the total weight of the ink composition. In a preferred embodiment, the catalyst is dispersed on a support such as carbon black or nanotube which is also present in an amount of 1 to 10 weight of the total weight of the ink composition.

In another embodiment, a method for making a catalyst layer for a fuel cell is provided. The method comprises combining a first liquid composition with an onium compound to form a second liquid composition. The first liquid composition includes a solvent system, a supported catalyst, and an ion-conducting polymer. Characteristically, the onium compound includes a hydrophobic hydrocarbon moiety. The catalyst layer is then formed from the second liquid composition by printing the catalyst layer onto the ion-conducting membrane (CCM, catalyst-coated-membrane), onto a sacrificial polymer decal (CCD, catalyst-coated-decal) or onto the gas diffusion layer (CCDM, catalyst-coated-diffusion media).

Another feature of the present invention is the hydrophobicity of the solvent system. The hydrophobicity for either a solvent mixture or organic solute can be calculated as a logarithm of the partition coefficient (log P) between an immiscible oil (typically n-octanol as in this case) and water phases. This procedure is described in “Substituent Constants for Correlation Analysis in Chemistry and Biology”, C. Hansch and A. Leo (Wiley and sons) 1979 and “Partition Coefficients and their Uses”, A. Leo, C. Hansch, and D. Elkins, Chem Rev 71 (1971) 525-616; the entire disclosures of these publications is hereby incorporated by reference. A high log P implies a more hydrophobic solvent or solute that would be preferentially partition into the n-octanol phase. In addition, the hydrophobicity can be calculated as the logarithm of its water solubility. This procedure is described in “Estimation of the Aqueous Solubility of Organic Molecules by the Group Contribution Approach”, G. Klopman and H. Zhu, J. Chem. Inf. Comput. Sci. 41 (2001) 439-445 and “Modeling Aqueous Solubility”, D. Butina and J. Gola, J. Chem. Inf. Comput. Sci. 43 (2003) 837-841, the entire disclosures of these publications is hereby incorporated by reference.

In a variation using oleylamine dispersant, the solvent mixture hydrophobicity should be higher than log P=−0.79. Table 1 shows the precipitation of the oleylamine solute into oil droplets as the threshold hydrophobicity series is reached with increasing water weight fraction in a water/n-propanol (nPrOH) solvent composition series at 15° C. The oil droplets are detected by the increased turbidity (in NTU or nephelometric units) at 75% water fraction (w/w).

TABLE 1
Measured turbidity of oleylamine solute in water/n-propanol
solvent mixtures at 15 and 25° C.

| | Sample 1 | Sample 2 | Sample 3 |
|---|---|---|---|
| mmol | 25.0 | 25.0 | 25.0 |
| amine/kg | | | |
| nPrOH solvent | 75% | 50% | 25% |
| fraction | | | |
| calc logP | −0.07 | −0.43 | −0.79 |
| nPrOH | 54.84 | 36.22 | 17.59 |
| H2O | 18.28 | 36.91 | 55.53 |
| stock amine | 1.88 | 1.88 | 1.88 |
| (1000 mmol/kg) | | | |
| total | 75.00 | 75.00 | 75.00 |
| NTU(25 C., 3 hr | 0.10 | 0.13 | 0.44 |
| hold) | | | |
| NTU (15 C., 3 hr | 0.58-0.28 | 0.31-0.16 | 55.8-47.6 |
| hold) | | | |

The corresponding calculated hydrophobicity (log P) of different solvents is given in Table 2.

TABLE 2
The calculated logP for different solvents.
Calculated Hydrophobicity

| solvent mixture | log P |
|---|---|
| (w/w) | (fragment addition) |
| H2O | −1.15 |
| EtOH | −0.24 |
| nPrOH | 0.29 |
| glycerol | −2.08 |
| nPrOH:H2O::3:1 | −0.07 |
| EtOH:H2O:nPrOH::2:2:1 | −0.50 |
| EtOH:H2O::1:1 | −0.69 |
| glycerol:H2O:nPrOH::90:4:6 | −1.90 |

The Nafion® polymer begins to phase-separate from the water/n-propanol solvent mixture at 75% water fraction when complexed with oleylamine dispersant at 50% mol/mol neutralization at both 15 and 25° C. as shown in Tables 3 and 4. As a result, the oleylamine dispersant addition is limited to PEMFC electrode inks with a calculated hydrophobicity for the solvent mixture of log P>−0.79.

TABLE 3
Measured turbidity and viscosity for Nafion ® polymer without
oleylamine neutralization in a water/n-propanol solvent series.
(The Dupont D2020 dispersion contains 21.6% Nafion ® in
nPrOH:H2O::4:3 w/w solvent.)

| | Sample 1 | Sample 2 | Sample 3 |
|---|---|---|---|
| mmol | 0.0 | 0.0 | 0.0 |
| amine/kg | | | |
| PFSA w/w | 5.0% | 5.0% | 5.0% |
| mmol H+/kg | 49.9 | 49.9 | 49.9 |
| nPrOH solvent | 75% | 50% | 25% |
| fraction | | | |
| calc logP | −0.07 | −0.43 | −0.79 |
| nPrOH | 45.72 | 27.90 | 10.09 |
| H2O | 11.99 | 29.80 | 47.61 |
| Dupont D2020 | 17.30 | 17.30 | 17.30 |
| Total | 75.00 | 75.00 | 75.00 |
| NTU(25 C., 3 hr | 0.94 | 0.62 | 0.53 |
| hold) | | | |
| mPa-s (25 C., 3 hr | 11.79 | 15.73 | 12.26 |
| hold, 40/sec) | | | |
| Relative | 3.37 | 4.51 | 5.45 |
| viscosity | | | |
| NTU (15 C., 3 hr | 0.95 | 0.62 | 0.53 |
| hold) | | | |
| mPa-s (15 C., 3 hr | 11.88 | 16.08 | 13.07 |
| hold, 40/sec) | | | |
| Relative | 3.39 | 4.61 | 5.81 |
| viscosity | | | |

TABLE 4
Measured turbidity and viscosity for Nafion ® polymer neutralized
at 50% mol/mol with oleylamine in a water/n-propanol solvent series.

| | Sample 1 | Sample 2 | Sample 3 |
|---|---|---|---|
| mmol amine/kg | 25.0 | 25.0 | 25.0 |
| PFSA w/w | 5.0% | 5.0% | 5.0% |
| mmol H+/kg | 49.9 | 49.9 | 49.9 |
| nPrOH solvent | 75% | 50% | 25% |
| fraction | | | |
| calc logP | −0.07 | −0.43 | −0.79 |
| nPrOH | 44.31 | 26.62 | 8.94 |
| H2O | 11.52 | 29.20 | 46.89 |
| Dupont D2020 | 17.30 | 17.30 | 17.30 |
| Total | 75.00 | 75.00 | 75.00 |
| NTU(25 C., 3 hr | 1.10 | 0.84 | ppt |
| hold) | | | |
| mPa-s (25 C., 3 hr | 7.14 | 8.37 | 30.20 |
| hold, 40/sec) | | | |
| Relative | 2.04 | 2.40 | 13.42 |
| viscosity | | | |
| NTU (15 C., 3 hr | 1.13 | 0.82 | ppt |
| hold) | | | |
| mPa-s (15 C., 3 hr | 7.66 | 8.99 | 68.98 |
| hold, 40/sec) | | | |
| Relative | 2.19 | 2.58 | 30.88 |
| viscosity | | | |

The calculated hydrophobicity for the amine dispersant should be log P>1.9 and the log(water solubility, g/L)<0.3 to drive adsorption of the perfluorosulfonated (PFSA) polymer onto the Pt/C electrocatalyst surface.

Table 5 summarizes the calculated hydrophobicity for the alkylamine structure with increasing carbon length. The calculated log P and log(water solubility) of model uncharged amine structures estimate the relative hydrophobicity of the corresponding ammonium cations. The logarithm of the partition coefficient between n-octanol oil and water phases (log P) is frequently used to estimate component hydrophobicity. A 10-fold higher component concentration separates into the water-phase at log P=−1.0, while a 10⁷-fold higher component concentration partitions into the n-octanol oil-phase at log P=7.0. The C₁₈ aliphatic chain on oleylamine (OA) has a high component hydrophobicity with a calculated preferential separation into the n-octanol oil phase of log P=7.73.

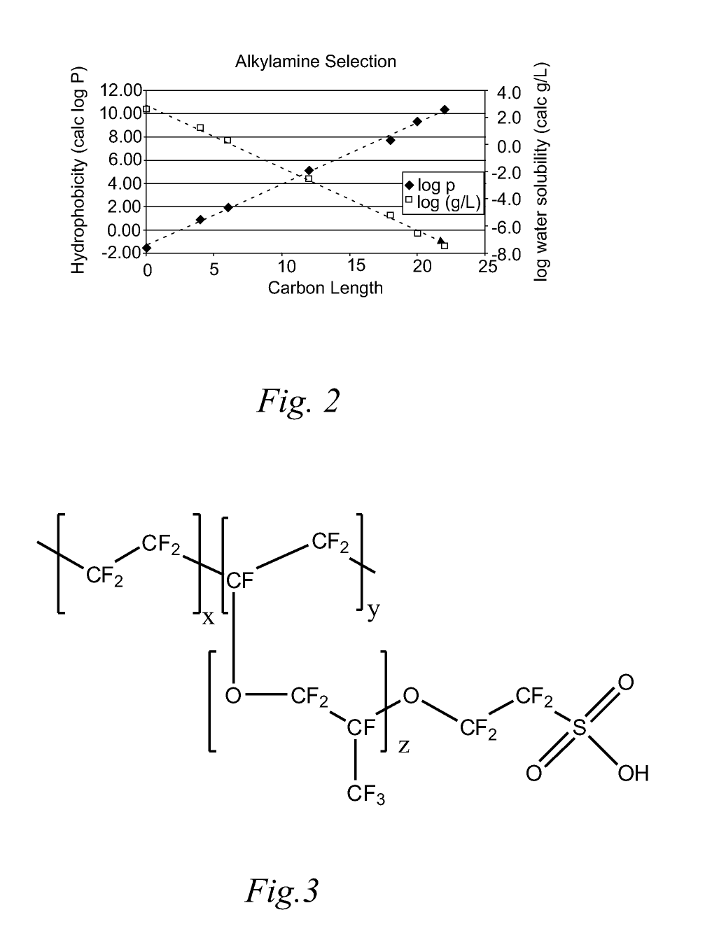

An alkylamine hydrophobicity greater than hexylamine is required to drive the adsorption of the partially neutralized PFSA polymer. In addition, the vapor pressure of the lower alkylamines such as hexylamine is too high. Even though the extrapolated hydrophobicity for tetra-n-butylammonium hydroxide approaches oleylamine due to the similar carbon count, the oleylamine dispersant has a longer and more flexible single chain that can better condense on the Pt/C surface. As a result, the preferred embodiment comprises either primary or secondary amine dispersant that permits a greater fraction of the available aliphatic chain to contact the colloidal surfaces in the PEMFC ink suspension. FIG. 2 provides the calculated log P and log(water solubility) for a homologous series of aliphatic amines with increasing carbon length.

TABLE 5
Calculated logP and water solubility for different amine structures.

| | | | | log(water | |
|---|---|---|---|---|---|
| | | | water | solubility) | |
| | | log P (fragment | solubility | (Klopman, | carbon |
| name | structure | addition) | (Klopman) | log(g/L)) | count |
| ammonia | NH₃ | −1.54 | 0.4 kg/L | 2.6 | 0 |
| n-butylamine | NH₂ (Bu) | 0.86 | 17.0 g/L | 1.2 | 4 |
| hexylamine | NH₂(C₆H₁₃) | 1.92 | 2.2 g/L | 0.3 | 6 |
| dodecylamine | NH₂(C₁₂H₂₅) | 5.10 | 3.0 mg/L | −2.5 | 12 |
| oleylamine | NH₂(C₁₈H₃₅) | 7.73 | 6.1 μg/L | −5.2 | 18 |
| eicosylamine | NH₂(C₂₀H₄₁) | 9.33 | 0.3 μg/L | −6.5 | 20 |
| docosylamine | NH₂(C₂₂H₄₅) | 10.39 | 33.2 ng/L | −7.5 | 22 |
| triethanolamine | N(EtOH)₃ | −1.83 | 2.8 kg/L | 3.4 | 6 |
| di-(nbutyl)amine | N(Bu)₂H | 2.75 | 0.5 mg/L | −0.3 | 8 |
| tri-(nbutyl)amine | N(Bu)₃ | 5.13 | 2.8 mg/L | −2.6 | 12 |

In a refinement of the present invention, the solvent system includes an alcohol (e.g. ethanol, propanol, etc) and water with 25-40 weight percent being water and the balance alcohol(s). Examples of solvent systems include, but are not limited to, ethanol, water and propanol in a weight ratio of 2:2:1 or n-propanol and water in a weight ratio of 3:1. The solvent systems of this refinement have been particularly useful when oleylamine is used for the neutralization. In a further refinement, when the amine is dodecylamine, a more hydrophilic solvent system such as glycerol, water and n-propanol in a weight ratio of 90:4:6 is useful. In yet a further refinement, these solvent systems are combined with conventional catalysts such as Pt/V (Pt dispersed on Vulcan carbon black) or PtCoHSC (Pt-alloy dispersed on Ketjen carbon black) or PtCoF (Pt-alloy dispersed on F-type carbon black) from Tanaka Kikinzoku Kogyo K.K. (TKK) and perfluorosulfonated ionomers (Dupont D2020 dispersion for Nafion® or other PFSA polymers at equivalent weight from 700-1100 g/mol) in the amounts set forth above.

The following examples illustrate the various embodiments of the present invention. Those skilled in the art will recognize many variations that are within the spirit of the present invention and scope of the claims.

### Materials

Dupont D2020 dispersion is used as the stock Nafion® polymer for the PtCoHSC electrode inks. The dispersion solids are measured at 21.6+−0.1% after drying at 120° C. in nPrOH:H₂O::4:3 w/w solvent (Arizona Instrument Moisture Analyzer MAX1000); the polymer equivalent weight (EW) is measured at 950+-10 g/mol in 1M NaCl solution (400 mol/mol stoichiometric excess) which is used to release the hydronium counterion into solution (Mettler-Toledo DL15 Titrator).

This EW gives a 16.5% molar fraction of sulfonate monomer along the polymer backbone and an average 11.1 CF₂ units between the sulfonate side-chain branch points. The Nafion® single-chain is measured at M_{w}=3.34×10⁵ D with M_{w}/Mₙ=1.75, while the non-autoclaved dispersion shows an apparent M_{w} at 1790 kD which is assigned to an aggregate with 5.3 weight-average single-chains.

In addition, lower EW PFSA dispersion is used for model system measurement and is received at 20.5+-0.1% solids in pure H₂O solvent with EW=720+−5 g/mol, M_{w}=5.21×10⁵ D and M_{w}/Mₙ=1.87. The C2 side-chain structure (z=0 in FIG. 3) gives 18.5% molar fraction of sulfonic acid monomer along the polymer backbone and an average 9.8 CF₂ units between side-chain branch points.

Catalysts and related carbon blacks are purchased from Tanaka Kikinzoku Kogyo K.K. (TKK). One Pt-alloy catalyst is supported on HSC (high surface area or Ketjen) carbon black containing 28.7% Pt and 2.5% Co w/w; while the other Pt-alloy catalyst is supported on F-type carbon black containing 30.8% Pt and 2.6% Co w/w.

A non-woven diffusion media is selected where a thin (˜30 μm) microporous layer (MPL) containing carbon black and poly(tetrafluoroethylene) PTFE beads is in contact with the cathode layer, while the thicker (˜200 μm) carbon paper with PTFE beads is in contact with the bipolar plate in the PEMFC cell.

Neat oleylamine (OA) liquid (C₁₈H₃₇N, cis-9-octadecenylamine, CAS=112-90-3, MW=267.49, 0.810 g/cm³, melting point=15-22° C., vapor pressure=1 Ton at 120° C.) is obtained from Acros Organics with a nominal purity of 97+% primary amine and 80+% C18 aliphatic fraction.

Commercial highly ordered pyrolytic graphite wafers (HOPG with low mosaic angle) are purchased from GE Materials Quartz Inc; the ZYA grade wafer has a 12 mm×12 mm×2 mm rectangular dimension. The isoelectric point (IEP) for a similar cleaved HOPG surface is measured at pH=2.25 in H₂O and at pH(e)=4.25 in EtOH:H₂O::1:1 w/w solvent; however, the IEP depends on the surface step density and varies between 4.0-4.6 in EtOH:H₂O::1:1 w/w solvent with replicate cleaves.

Pt-whisker (nanostructured thin film, NSTF) decals are obtained in roll form from 3M Corporation. The laydown is measured at 0.15 mg Pt/cm² with a 15.5+−0.5 roughness factor.

### Rheometer

A HAAKE MARS instrument is used to measure ink rheology at 25° C. A cone and plate (C60/1° Ti spindle) geometry is selected with 60 mm diameter, cone angle at 1° and gap at 0.052 mm. The measurement protocol applies an up-down shear-rate ramp from 0.01-100 sec⁻¹.

### Low Angle Laser Light Scattering (LALLS)

A Beckman Coulter model LS 13320 LALLS system is used to measure the ink particle size distribution. The PtCoHSC ink size distribution is quenched by dilution to 0.10% w/w carbon loading in EtOH:H₂O::1:3 w/w. The quenched samples are then measured without sonication using the same diluent in the system reservoir.

### Zeta Potential Measurement

The HOPG substrates are measured using a ZetaSpin instrument. One inch diameter disks (5.07 cm² area) are cut from the initial HOPG wafers. HCl is used for pH/pH(e) adjustment with 0.05 M KCl background electrolyte.

### Fuel Cell Performance

Each membrane-electrode assembly (MEA) has 50 cm² active area; it is laminated using a single commercial reinforced perfluorosulfonated (PFSA) membrane, a single standard anode and the cathode variations. Prior to the beginning-of-life (BOL) voltage performance measurement, each cell is first submitted to a recovery protocol that comprises a 3-hour hold at 40 C and 0.3V. The H₂/air polarization curves are measured at 80 C with a counterflow reactant gas flow pattern at 1.5/2.0 stoic; two replicate cells are tested for each cathode variation. For the dry protocol, the inlet relative humidity (RH) of 32% and pressure of 150 kPa are set at both electrodes; while the cathode outlet RH is calculated as 87% for a 1.5 A/cm² current density. For the wet protocol, the inlet RH of 100% and pressure of 170 kPa are set at both electrodes; while the cathode outlet RH is calculated as 156% for a 1.5 A/cm² current density.

### Results & Discussion

### 1) Colloidal Stabilization of the PtCoHSC Electrode Ink

a) Ink Formulation

The PtCoHSC cathode layer is coated on either a sacrificial ethylene-tetrafluoroethylene (ETFE) alternating co-polymer decal (CCD) or directly on diffusion media (CCDM). The material composition, order-of-addition and milling condition for a representative CCDM PtCoHSC electrode ink is given in Table 6.

The calculated solids include oleylamine (which has low vapor pressure so does not evaporate during solvent drying). The total solids scales with the formulated carbon loading which is formulated at 3.00%, 3.25 or 5.00% w/w in nPrOH:H₂O::3:1 w/w solvent.

Since the PFSA ionomer solution from the electrode ink seeps into the porous diffusion media during the CCDM coating process, the CCDM and CCD ink formulations differ in dry ionomer/carbon (I/C) weight ratio where an optimal I/C(CCDM)=1.40 and I/C(CCD)=0.95. Nafion® is used exclusively as the PFSA polymer for these coating trials.

To disperse the as-received catalyst, 5 mm-diameter ZrO₂ beads are added to the PtCoHSC ink and rolled for 1-day at 120 rpm. The calculated volume fractions (v/v) in the polyethylene bottle are 12.0% bead, 25.4% ink and 62.5% void. The inks are coated and measured immediately after the milling step as well as after an additional hold step where the ink fluid is transferred without milling beads to another polyethylene bottle and rolled again for 1-day at 120 rpm.

TABLE 6
PtCoHSC ink formulation for catalyst-coating-on-diffusion-media
(CCDM) cathode layer fabrication.
Ink Description: 30% PtCoHSC
Ink Formulation Sheet (Calculated Outputs)

| | | |
|---|---|---|
| Group 0 (catalyst) | 2.88 | g |
| Group 1 (ZrO₂ bead) | 195.00 | g |
| Group 2 | 38.35 | g nPrOH |
| (premix: ionomer + alcohol | 10.40 | g H2O |
| | 12.65 | g stock ionomer |
| Group 3 (amine add) | 0.718 | g amine solution |
| Ink Total | 65.00 | g |
| | 73.45 | cc |

Final Ink:

| | | |
|---|---|---|
| ink density (calc) = | 0.885 | g/cc |
| solids density (calc) = | 2.405 | g/cc |
| solvent density (calc) = | 0.833 | g/cc |
| ink solids (calc) = | 8.92% | |
| sulfonic acid (mmol/kg) = | 44.21 | |
| pH (calc, ionomer + amine) = | 1.88 | |
| bead fraction (v/v) = | 12.0% | |
| ink fraction (v/v) = | 25.4% | |
| void fraction (v/v total) = | 62.5% | |
| mill time = | 1 | days |

Catalyst Input

| | |
|---|---|
| type = | TKK 30% PtCoHSC |
| wt % volatiles (@ RT) = | 1.0% |
| wt % carbon (@ RT) = | 67.8% |
| wt % metal (@ RT) = | 31.2% |

Ionomer Input

| | |
|---|---|
| type = | D2020 |
| solids = | 21.58% |
| EW = | 950 |
| H2O = | 43.0% |
| nPrOH = | 57.0% |

Ink Input

| | |
|---|---|
| true carbon loading = | 3.00% |
| l/true C = | 1.40 |
| H2O = | 25% |
| nPrOH = | 75.0% |

Amine input

| | |
|---|---|
| stock solution conc (mmol/kg) = | 1000.00 |
| sulfonic acid equivalent = | 25% |

Process Input

| | |
|---|---|
| bottle volume (mL) = | 250 |
| ink weight (g) = | 65.0 |
| bead weight (g) = | 195.0 |

Three separate lots of neat oleylamine (OA) liquid from Acros Organics were tested for analytical purity and showed a similar mixture of primary amines. The components are measured by gas chromatography-mass spectroscopy (GC-MS) where Table 7 shows a C₁₈ weight fraction of 84.3% for the lot used in these PtCoHSC inks.

TABLE 7
An amine mixture with 84.3% C18 fraction is measured by GC-MS
headspace for the oleylamine lot used in the PtCoHSC ink makes.

| | |
|---|---|
| min | GC-MS |

| | | | |
|---|---|---|---|
| 19.184 | 1.14% | | C₁₄H₃₁N |
| 19.601 | 0.22% | | |
| 20.209 | 4.79% | | C₁₆H₃₃N |
| 20.298 | 5.99% | | C₁₆H₃₅N |
| 20.676 | 0.46% | | C₁₇H₃₅N |
| 20.719 | 1.12% | | C₁₇H₃₇N |
| 20.817 | 0.24% | | C₁₇H₃₁N |
| 21.225 | 74.89% | Oleylamine | C₁₈H37N |
| 21.309 | 7.44% | Octadecylamine | C₁₈H₃₉N |
| 21.424 | 1.98% | Oleanitrile | C₁₈H₃₃N |
| 21.519 | 0.72% | | |
| 21.683 | 0.59% | | |
| 22.135 | 0.44% | | |

b) Ink Rheology

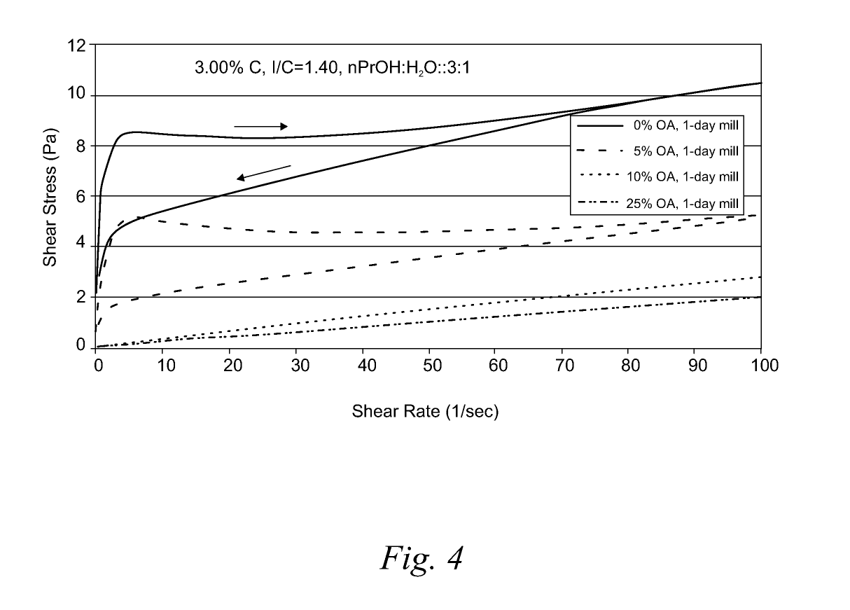

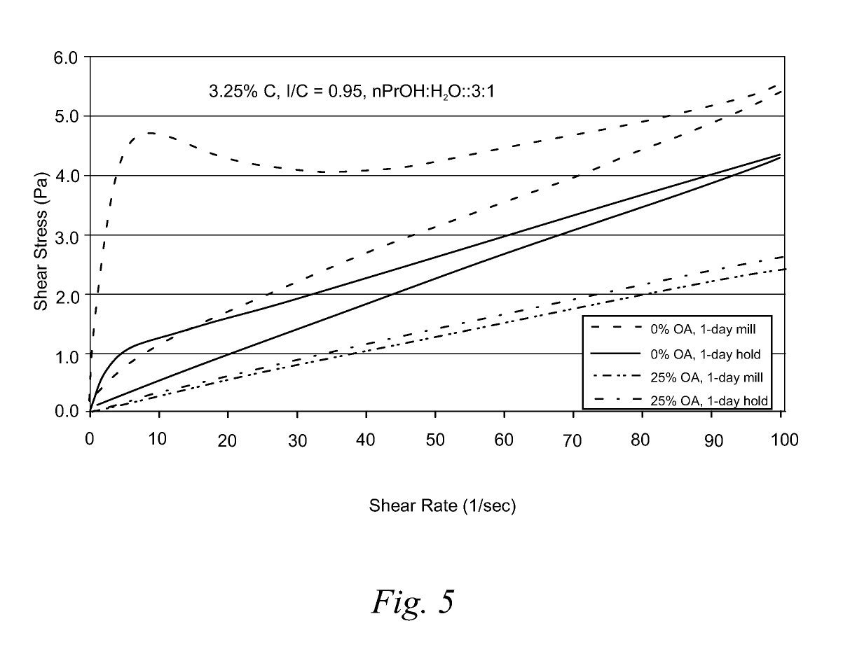

FIGS. 4 and 5 plot the fluid rheology for the CCDM and CCD PtCoHSC inks, respectively. Since the CCDM coating format typically gives a slightly better PEMFC voltage performance, it is selected for scale-up trials; however, the CCD format allows a parallel measurement of electrode porosity so it is included in this series.

Without OA amine addition, the CCDM ink shows significant yield stress and high viscosity after milling. With increasing OA neutralization of the Nafion® polymer, however, the CCDM ink develops a Newtownian flow character as observed by the low and constant viscosity that is measured without hysteresis over the applied shear-rate range. The shear stress of the CCDM ink decreases from 10.5 to 2.0 Pa at 100 sec⁻¹ with 0 to 25% OA mol/mol neutralization which translates into a viscosity decrease from 105 to 20 mPa-s. At 25% mol/mol neutralization, the amine component is only 7.0% of the dry Nafion® weight in the ink.

The CCD ink shows a similar result after 25% OA neutralization; however, the viscosity range is slightly lower due to the substantially lower ink I/C required for optimal voltage performance in this coating format. FIG. 5 also shows a slight shift with a 1-day ink hold after the milling process. In total, these fluid rheology measurements imply an improved colloidal stability for the PtCoHSC ink with OA addition for both CCDM and CCD coating formulations.

### Ink Particle Size Distribution (PSD)

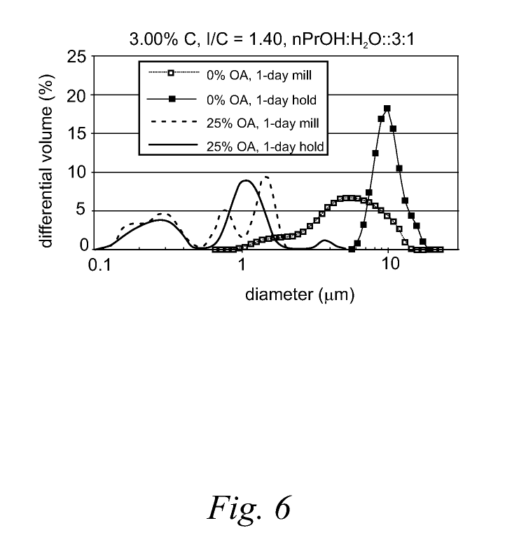

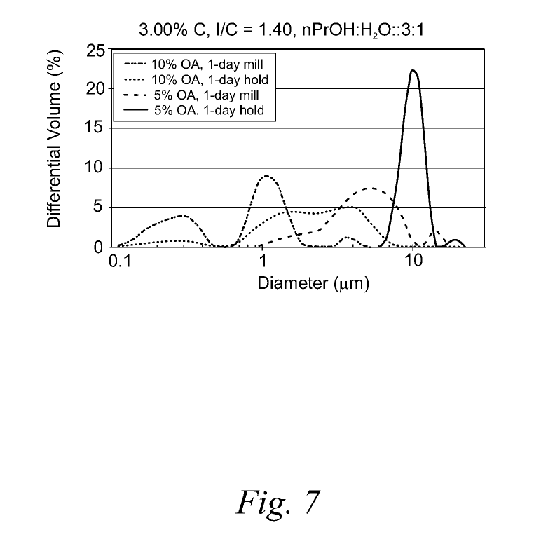

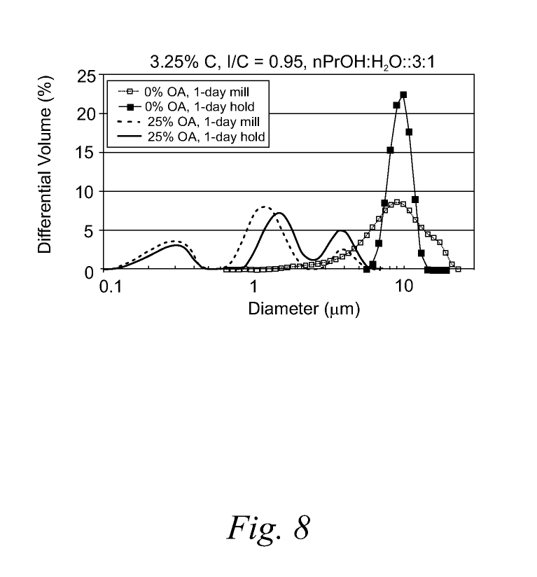

FIGS. 6 and 7 plot the measured particle size distribution for the PtCoHSC CCDM inks, while FIG. 8 shows a similar result for CCD inks. Without OA addition, the CCDM ink in FIG. 6 has a significantly larger particle diameter after milling which then grows after an additional 1-day hold to a monodisperse 10 μm diameter that approaches the dry electrode thickness. At 25% OA mol/mol neutralization, however, the CCDM ink shows a much smaller initial diameter distribution that is largely maintained with the additional 1-day hold.

FIG. 7 shows the impact of intermediate OA addition levels at 5 and 10% mol/mol neutralization; this helps determine the minimal addition amount required to obtain a lower diameter distribution after milling which is maintained with ink aging. The 5% neutralization level is clearly not sufficient, but the 10% level approaches the more stable PSD distribution given in FIG. 6. This suggests that the optimal OA loading lies between 10-25% mol/mol neutralization for the CCDM PtCoHSC ink.

Similarly, the PSD distribution in FIG. 8 for the CCD ink at 25% OA mol/mol neutralization shows a catalyst suspension with smaller agglomerate diameter after milling that is maintained with ink age. In total, these particle size measurements also imply an improved colloidal stability for the PtCoHSC inks with OA addition for both CCDM and CCD coating formulations. In fact, the PtCoHSC inks without sufficient OA neutralization show such a significant change in PSD distribution with ink aging that it highlights a likely concern in scale-up robustness and manufacturability.

c) Cracking in PtCoHSC Electrode Coatings

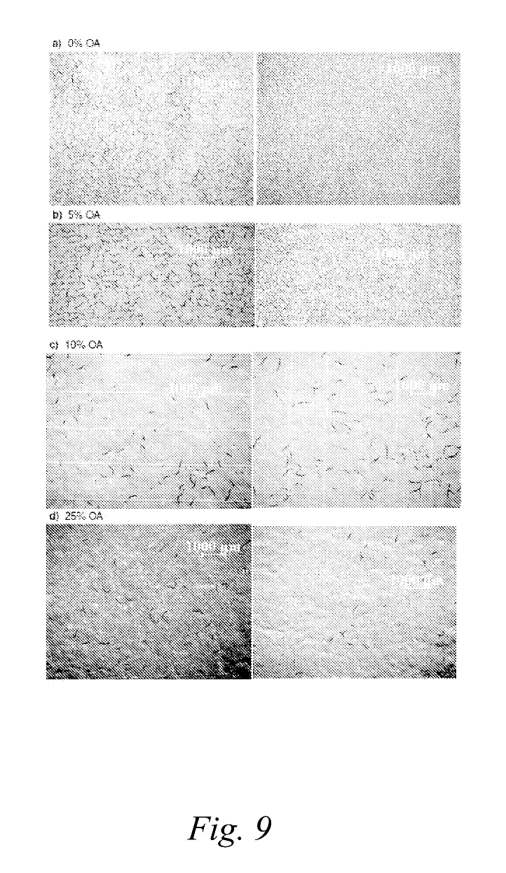

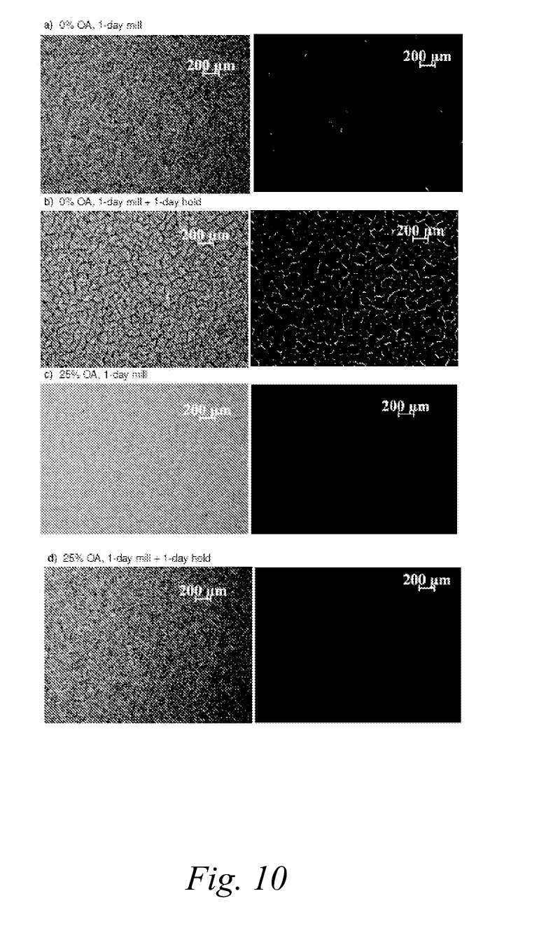

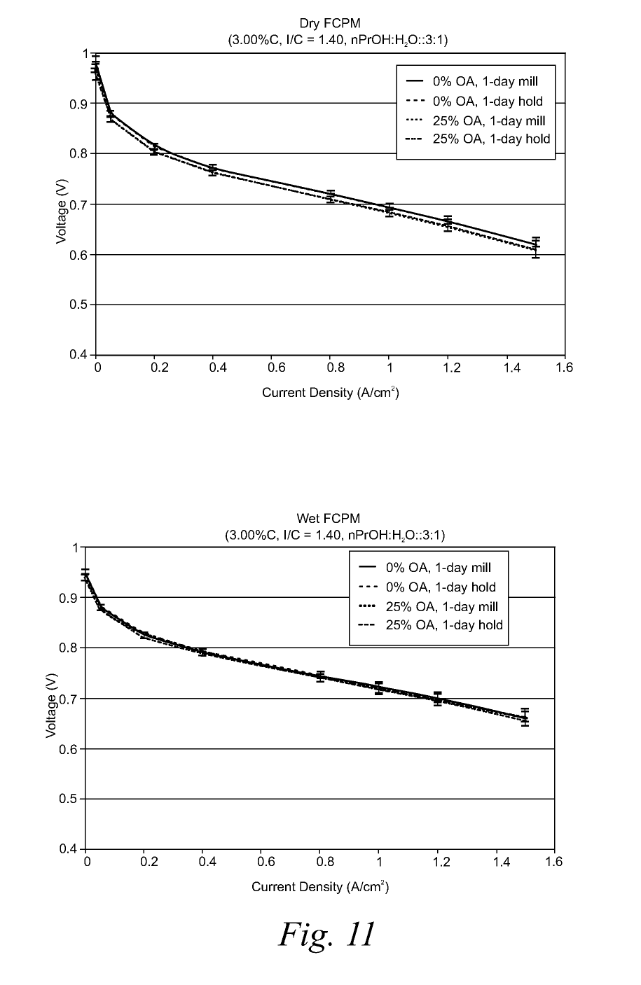

As the catalyst secondary agglomerate size increases in the ink prior to coating, the dry electrode cracking in FIGS. 9 and 10 increases as well. However, the resulting layer porosity and carbon volume fraction in Table 8 do not change within our measurement precision. Since the bulk of the polymer solution is external to the catalyst secondary agglomerate that forms in the ink suspension, the polymer deposition during solvent evaporation is likely skewed to the periphery of the agglomerate. As a result, we assign the higher crack yield to a non-uniform polymer location distribution in the electrode layer on a scale of the catalyst agglomerate diameter (5-10 μm) rather than a lower carbon packing density. This μm-scale non-uniformity can impact both the local stress and modulus in the drying electrode layer.

FIG. 9 shows the reflected light micrographs for PtCoHSC CCDM coatings at 0, 5, 10 and 25% OA mol/mol neutralization of the Nafion® polymer. The low magnification images cover sufficient area to estimate the electrode crack yield when coated immediately after 1-day mill (left-hand panel) and again after an additional 1-day hold (right-hand panel).

As found with measurement of ink rheology in FIG. 4 and PSD in FIGS. 6 and 7 for the same inks, the 0 and 5% OA neutralization shows a high crack yield when coated after milling which then increases substantially after an additional 1-day hold, while 10 and 25% mol/mol neutralization shows a much lower crack yield which is maintained with ink aging.

FIG. 10 shows reflected and transmitted light micrographs for the CCD PtCoHSC coatings on ETFE with 0 and 25% neutralization of the Nafion® polymer. Since the decal is transparent, the transmitted light micrographs clearly delineate the through-layer cracking.

The images again show significant electrode cracking at 0% OA mol/mol neutralization when coated after 1-day mill (10a), but a much higher yield with the additional 1-day hold (10b). On the other hand, there is no detectable layer cracking observed in the light micrographs for 25% OA neutralization after 1-day mill (10c) or after an additional 1-day aging (10d). In total, these top-view light micrographs show a significant reduction in layer cracking in the resulting PtCoHSC electrode for both CCDM and CCD coating formats when coated without significant secondary agglomeration of the PtCoHSC catalyst in the ink with OA addition.

Table 8 summarizes the dry CCD electrode thickness imaged in cross-section by Secondary Electron Microscopy (SEM) at a given measured gravimetric laydown; each electrode sample is averaged over 5 locations for the thickness measurement. The carbon volume fraction remains constant at 16.5% v/v for all PtCoHSC CCD coatings regardless of hold time or OA addition level; this indicates that catalyst colloidal stability and secondary agglomerate size do not impact the resulting packing density or porosity of the PtCoHSC electrode layer.

TABLE 8
SEM x-sectional thickness of CCD PtCoHSC electrodes.

| | | measured thickness | | gravimetric | carbon |
|---|---|---|---|---|---|
| CCD(ETFE) electrode | | | (RSD, | laydown | volume |
| variation | | (μm, avg) | std/avg) | (mg C/cm2) | (v/v) |
| 0% OA | 1-day mill | 15.4 | 3.2% | 0.508 | 16.6% |
| | 1-day mill + | 16.0 | 3.8% | 0.503 | 16.7% |
| | 1-day hold | | | | |
| 25% OA | 1-day mill | 15.0 | 3.3% | 0.498 | 16.6% |
| | 1-day mill + | 16.4 | 5.3% | 0.507 | 15.5% |
| | 1-day hold | | | | |

### Cathode Voltage Performance

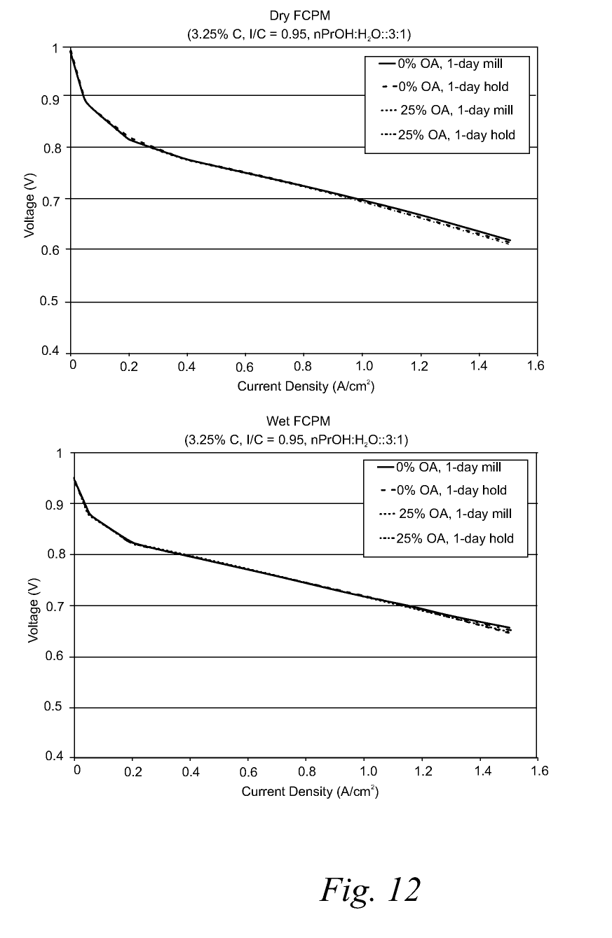

Equivalent beginning-of-life (BOL) voltage performance is also measured in 50-cm² scale testing of PEMFC fuel cells using PtCoHSC cathode layers at 0 and 25% OA addition levels. FIGS. 11 and 12 show voltage performance in dry and wet protocols for the CCDM and CCD coating formats, respectively.

With the 3 hour voltage recovery protocol, the OA additive does not appear to cause any BOL voltage loss due to contamination.

### 2) Underlying Mechanism Electrosteric Stabilization of Electrode Inks

a) PtCoF Ink Rheology: Amine Hydrophobicity Series

The hydrophobicity of model ammonium hydroxide components is varied as follows: triethanolamine NH(EtOH)₃OH→ammonia NH₄OH→tetra-(n-butyl)amine N(Bu)₄OH→oleylamine NH₃(C₁₈H₃₅)OH. The neat triethanolamine and oleylamine liquids are first diluted into stock alcohol-water solutions at 1000 mmol/kg concentration where the corresponding ammonium hydroxide salt forms, while the quaternary ammonium and tetra-(n-butyl)ammonium hydroxide solutions in water are received and diluted to the same working concentration and alcohol-water solvent composition. These stock solutions are then added to model PtCoF inks where the hydroxide anion is neutralized by PFSA sulfonic acid and the ammonium cation is complexed to the polymer chain.

Although each cation carries the same formal charge for electrostatic interaction with the PtCoF catalyst surface, only the oleylammonium cation has an extended hydrophobic C₁₈ tail. The tetra-(n-butyl)ammonium cation has nearly the same carbon mass (C₁₆), but the individual aliphatic tails (C₄) are much shorter in length with less hydrophobic contact area available for adsorption on the HOPG graphite or carbon black surface. The ammonium cation is more hydrophilic since it has no aliphatic content, while triethanolammonium has short aliphatic tails that terminate in a hydrophilic alcohol group.

The ink solvent composition must also be designed to support the more hydrophobic Nafion® chain after it is complexed with aliphatic ammonium cation. As a result, the PtCoHSC ink is intentionally formulated in an alcohol-rich solvent (nPrOH:H₂O::3:1 w/w) to avoid early phase separation of complexed Nafion® during drying of the coated film.

Summary Table 9 shows that Nafion® polymer at 50% OA mol/mol neutralization does in fact phase-separate (ppt) in the transition to a water-rich solvent composition (nPrOH:H₂O::1:1→1:3 w/w). The relative viscosity (ηᵣₑₗₐₜᵢᵥₑ=ηₛₒₗᵤₜᵢₒₙ/ηₛₒₗᵥₑₙₜ) also increases significantly with polymer phase separation where ηₛₒₗᵤₜᵢₒₙ and ηₛₒₗᵥₑₙₜ are the solution and solvent-only viscosities, respectively.

TABLE 9
The turbidity (NTU) and viscosity (mPa-s) are summarized for a
Nafion ® solution in nPrOH:H₂O at 50% oleylamine when the
H₂O solvent fraction reaches 75% w/w.
Solution Stability

| | | | |
|---|---|---|---|
| Nafion PFSA w/w | 5.0% | 5.0% | 5.0% |
| oleylamine neutralization | 50% | 50% | 50% |
| H20 fraction | 25.% | 50% | 75% |
| nPrOH fraction | 75% | 50% | 25% |
| NTU (25 C., 3 hr hold) | 1.10 | 0.84 | ppt |
| mPa-s (25 C., 3 hr hold, 40/sec | 7.14 | 8.37 | 30.20 |
| relative viscosity | 2.04 | 2.40 | 13.42 |
| NTU (15 C., 3 hr hold) | 1.13 | 0.82 | ppt |
| mPa-s (15 C., 3 hr hold, 40/sec) | 7.66 | 8.99 | 68.98 |
| relative viscosity | 2.19 | 2.58 | 30.66 |

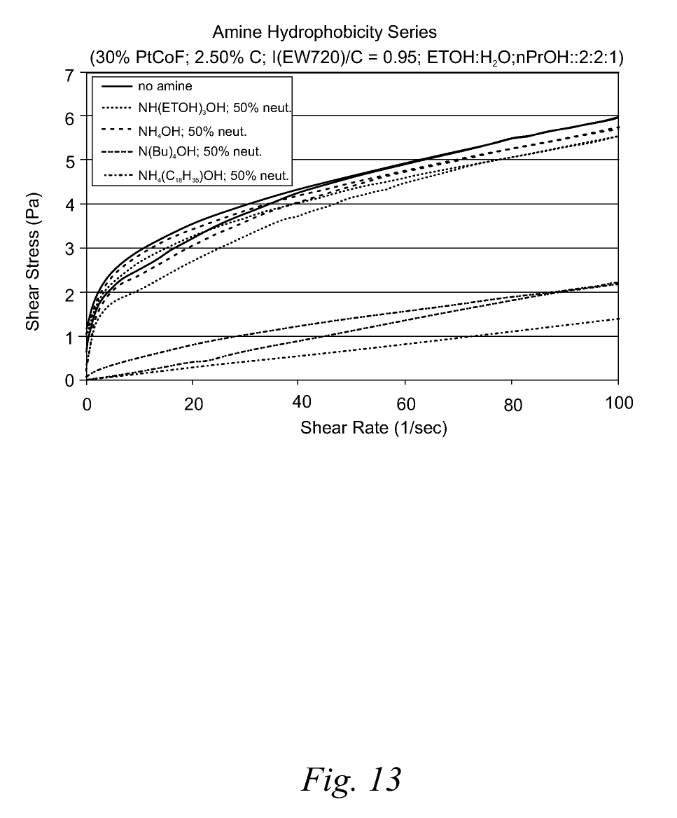

Viscometry is a useful screening tool for relative colloidal stability of particle suspensions. FIG. 13 shows the ink rheology for model PtCoF catalyst inks at 50% mol/mol neutralization of Nafion® polymer by amine components with increasing hydrophobicity. The shear-stress (σ) vs shear-rate (γ′) plots for the more hydrophilic ammonium and triethanolammonium additions appear similar to the “no amine” control.

In contrast, the more hydrophobic tetrabutylammonium and oleylammonium cation additions give a PtCoF ink rheology that approaches Newtownian flow where the measured viscosity (η=σ/γ′) remains constant with applied shear-rate (γ′). This difference is assigned to an improved colloidal stabilization of the catalyst ink with hydrophobic amine addition.

b) Carbon Black Ink Rheology: Oleylamine+Nafion® Polymer

The electrode ink viscosity depends on three separate formulation parameters: namely, the Nafion® polymer solution viscosity, the catalyst volume fraction and, most importantly, the catalyst colloidal stability. Both solution viscosity and catalyst volume fraction are easily assessed in separate measurements so the specific impact of poor catalyst colloidal stability on suspension viscosity can be directly evaluated.

In the simplest suspension viscosity model, the ink carries a dilute, non-interacting particle concentration (i.e., no agglomeration); in this case, the viscosity (ηₛᵤₛₚₑₙₛᵢₒₙ) is predicted by the Einstein equation (4). The intrinsic viscosity ([η]) depends only on the particle shape where a sphere has [η]=2.50 and a rod at Length/Diameter=2.0 has [η]=2.72. As a result, ηₛᵤₛₚₑₙₛᵢₒₙ is proportional to the continuous phase viscosity (which is polymer solution viscosity ηₛₒₗᵤₜᵢₒₙ in the electrode ink) and increases linearly with particle (catalyst) volume fraction (φ).

ηₛᵤₛₚₑₙₛᵢₒₙ=ηₛₒₗᵤₜᵢₒₙ*(1+[η]*φ) (4)

(dilute, non-interacting limit where [η]=2.50 for sphere or [η]=2.72 for rod with L/D=2.0)

In the next limiting case, the ink contains a high concentration of non-interacting particles. The model viscosity is now predicted by the Krieger-Dougherty equation (5) where a divergence occurs as the maximum random particle volume fraction (φₘₐₓ) is approached. In one example, monodisperse spheres are calculated to have φₘₐₓ=64% v/v. These concentrated fluids already show shear-thinning behavior where spherical particles, for example, arrange into hexagonal planes across the shear field to reduce their apparent viscosity at high applied shear-rate.

$${η}_{suspension} = {η}_{solution} * {( 1 - \frac{φ}{{φ}_{m ax}} )}^{- [ η ] * {φ}_{m ax}} \qquad ( 5 )$$

(concentrated, non-interacting limit where φₘₐₓ=64% for monodisperse spheres)

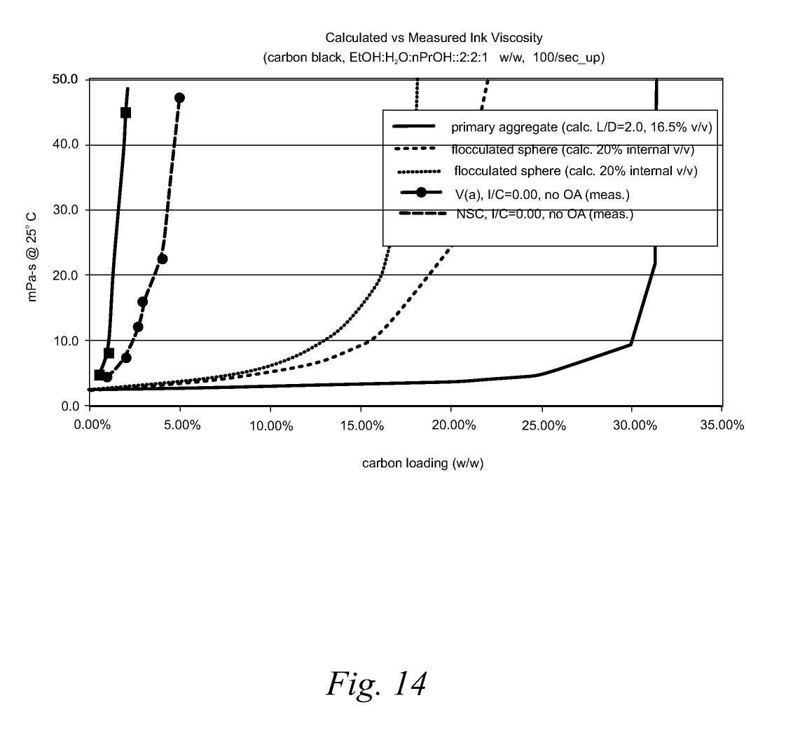

Most experimental particle suspensions, however, show a much higher viscosity than predicted by the non-interacting particle equations at the dilute (4) or concentrated (5) limit. This discrepancy is due to particle colloidal instability and is easily observed in FIG. 14 which plots the measured viscosity against carbon loading for amorphous Vulcan (Vₐ) and high-surface area (HSC or Ketjen) carbon black suspensions in EtOH:H₂O:nPrOH::2:2:1 w/w solvent (i.e., no Nafion® polymer in solution).

The Krieger-Dougherty equation (5) is used to calculate the expected carbon black ink viscosity without particle agglomeration at an assumed φₘₐₓ=16.5% v/v for the HSC carbon black and 20.0% v/v for Vₐ. The resulting calculated suspension viscosity (solid red) only reaches 10 mPa-s at 30% w/w carbon loading.

The simplest particle agglomeration model assumes a flocculated sphere with a monodisperse diameter distribution. In this case, the solvent that fills the internal volume of the flocculated sphere is counted as part of the particle volume fraction which leads to a viscosity divergence at lower carbon loading. We again calculate the suspension viscosity using equation (5), but now assume a maximum random packing density for HSC and V(a) carbon blacks at 16.5% and 20.0% v/v within the flocculate and another packing density for the spherical flocculates at 64% v/v. Since the external area of the spherical flocculate is minimized, these secondary particles are approximated as non-interacting. However, the resulting calculated curves in FIG. 14 (solid blue and green) still show that a 10 mPa-s viscosity is only reached at 12.5-15.0 w/w carbon loading.

On the other hand, the actual carbon black suspensions reach 10 mPa-s viscosity below 3% w/w loading which is assigned to the formation of extended (L/D>>2) stress-bearing carbon black chains. The calculated φₘₐₓ decreases rapidly with increasing L/D which then can jam the mobility of the carbon black chain at much lower volume fraction. Due to an attractive particle energy (U), the chains can bear a finite shear stress before decoupling which is responsible for the yield stress observed in the ink flow curves.

In the most general agglomeration model, the viscosity for a concentrated suspension of interacting particles is predicted by equation (6) where the suspension viscosity diverges by a power law with exponent α as the maximum particle volume fraction φ_{c} is approached. The critical parameters α, φ_{c} are determined by the coupling energy (U) of the particle agglomerate (which is a direct measure of colloidal stability) and by the applied shear stress (σ).

ηₛᵤₛₚₑₙₛᵢₒₙ=ηₛₒₗᵤₜᵢₒₙ*(φ_{c}−φ)^{-α} (6)

(concentrated, interacting limit where critical parameters φ_{c} and a depend on the coupling energy and applied stress)

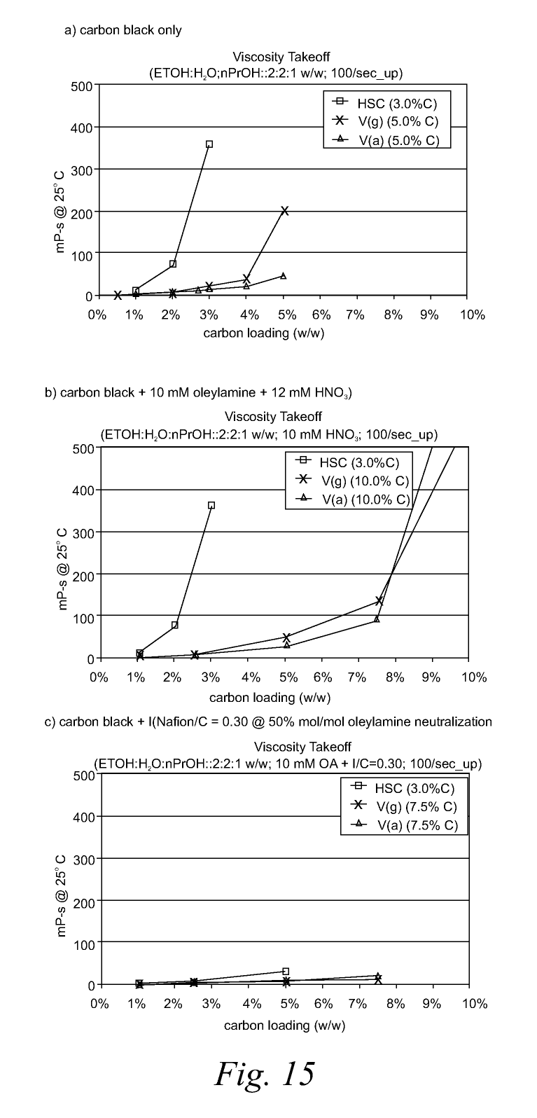

FIG. 15 shows the progression in measured viscosity for Vulcan (Vₐ), graphitized Vulcan (V_{g}) and Ketjen (HSC) carbon black suspensions with oleylamine and Nafion® polymer addition to EtOH:H₂O:nPrOH::2:2:1 w/w solvent. A low solution pH(e) is maintained by adding either HNO₃ mineral acid or Nafion® polymer to offset the basic oleylamine. The combination of oleylamine and Nafion® polymer is found to be most effective in reducing the measured suspension viscosity which is assigned to electrosteric stabilization by an adsorbed Nafion® polymer shell.

c) Zeta Potential:: OA+Nafion® Adsorption on HOPG

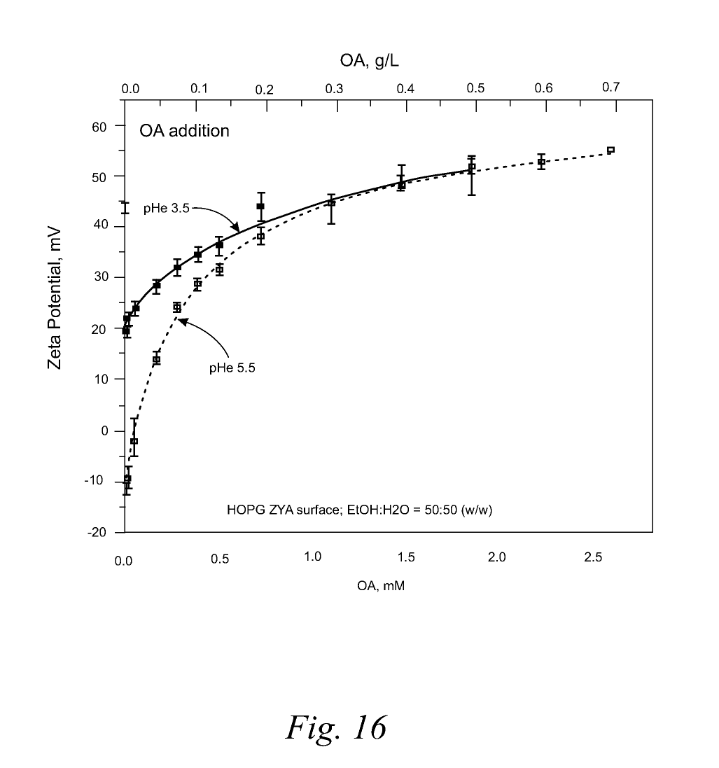

FIG. 16 plots the measured zeta potential (ξ) for a HOPG graphite wafer surface against increasing OA concentration in EtOH:H₂O::1:1 w/w solvent at pH(e)=3.5 vs 5.5. Before OA addition, this HOPG sample starts with potential 4=+20 mV at pH(e)=3.5 and with 4=-10 mV at pH(e)=5.5. For reference, the bare HOPG surface shows a neutral potential 4=0.0 mV in the pH(e)=4.0-4.6 range for EtOH:H₂O::1:1 w/w solvent depending on the step density created with a particular wafer cleave.

Oleylammonium cation adsorption causes a positive charge to develop with increasing amine concentration in solution. Assuming ammonium coverage scales with measured zeta potential, the plots in FIG. 16 are fitted to a Langmuir adsorption model where strong adsorption equilibrium constants are obtained: namely, K_{eq}(pHe=3.5)=1.5+-0.3 and K_{eq}(pHe=5.5)=3.1+-0.1 mM⁻¹.

In a similar result, hydrophobic cetyltrimethylammonium (CTA) cation adsorbs strongly on a Printex XE2 carbon black that is dispersed in H₂O, but the hydrophobic di(iso-octyl)succin-1-sulfonate anion does not. In combination, these results suggest that oleylammonium adsorption is driven by both the hydrophobic interaction of its extended C18 tail with the carbon support as well as the electrostatic interaction of its cationic head group with the aromatic π-system on the surface.

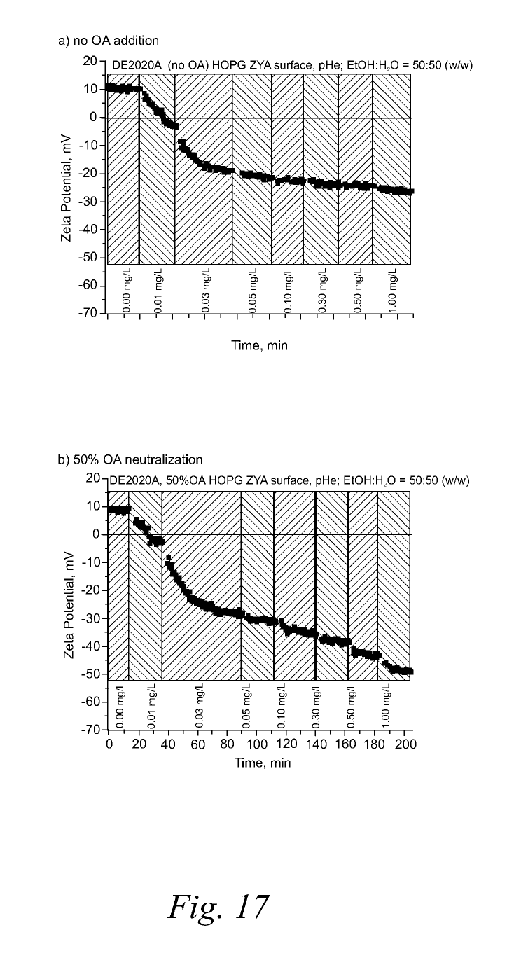

FIG. 17 indicates that Nafion® polymer adsorbs more strongly on the HOPG graphite surface after 50% OA mol/mol neutralization in the EtOH:H₂O::1:1 w/w solvent at pH(e)=4.0; the polymer is first neutralized as a stock solution at 190 mg Nafion®/L before step-wise addition to the Zetaspin instrument reservoir.

Without OA neutralization, the polymer adsorption approaches saturation coverage with a measured ξ=−27 mV at 1 mg Nafion®/L concentration. With 50% OA neutralization, the measured potential falls further to ξ=−50 mV at 1 mg Nafion®/L, even though the oleylammonium cation adds a neutralizing positive charge density to the HOPG surface.

d) Secondary Electron Microscopy (SEM): Nafion® Adsorption on Pt-Whisker Decal

This section uses a model Pt-whisker (NSTF) electrode decal to demonstrate that oleylamine addition also drives Nafion® adsorption on the Pt metal surface. A dilute polymer overcoat solution is applied to the NSTF electrode decal where a 40.0 μm wet thickness is applied by rod coating over a 3 mil gap shim that surrounds the underlying electrode decal. The aim average dry Nafion® thickness is then controlled by setting the polymer concentration in EtOH:H₂O:nPrOH::2:2:1 w/w solution with adjusted pH(e)=2.5. For example, a 0.116% w/w Nafion® concentration is used to achieve a 1.25 nm average dry thickness across the Pt surface area of the NSTF electrode decal.

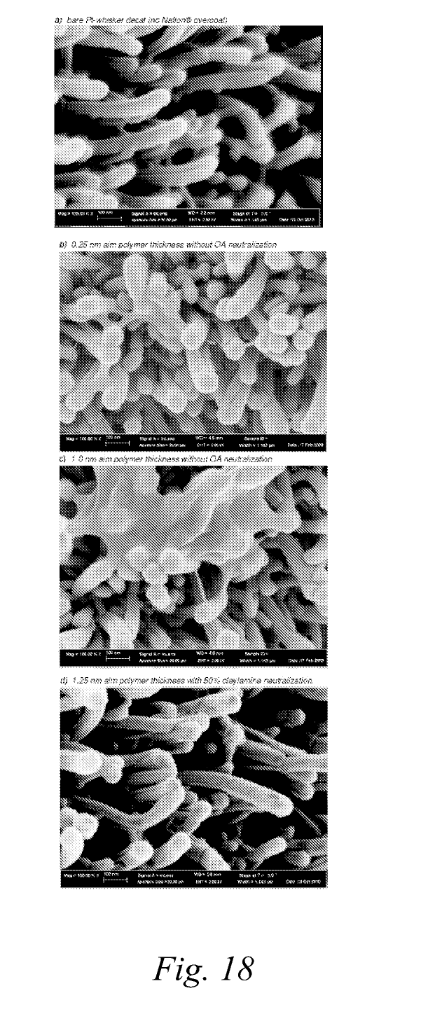

FIG. 18 shows a series of top-down SEM micrographs of the NSTF decal after drying the applied overcoat polymer solutions. The top panel (18a) shows the bare NSTF electrode as reference where the whisker template is covered with vapor-deposited Pt to give a measured 15.5 roughness factor. The next panel (10b) images a phase-separated Nafion® film that is distributed interstitially between the Pt whiskers for an overcoat solution without oleylamine at only an aim dry thickness of 0.25 nm. Even at this low aim coverage, Nafion® does not strongly adsorb on the available Pt surface so the polymer remaining in solution deposits as a distributed phase-separated film after solvent evaporation.

Panel (10c) shows a heavier film deposit of interstitial, phase-separated Nafion® as expected for an overcoat solution without oleylamine at an aim dry thickness of 1.00 nm. In contrast, panel (10d) shows no evidence of Nafion® phase separation at an even higher aim dry thickness of 1.25 nm for an overcoat solution with 50% mol/mol OA neutralization. This indicates that Nafion® with 50% OA neutralization can reach an adsorption coverage of at least 2.5 mg/m² on the Pt surface in EtOH:H₂O:nPrOH::2:2:1 w/w solvent at pH(e)=2.5 which is a reasonable solution condition for actual electrode inks.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An ink composition for forming a fuel cell layer, the ink composition comprising:
a solvent system;
an ion-conducting polymer dispersed within the solvent system;
a supported catalyst dispersed within the solvent system; and
an onium compound having a hydrophobic hydrocarbon moiety, the onium compound being substantially soluble in the solvent system.

2. The ink composition of claim 1 wherein the hydrophobic hydrocarbon moiety is selected from the group consisting of C₅-C₃₀ alkyl, C₅-C₃₀ alkenyl, and C₆-C₃₀ aryl.

3. The ink composition of claim 1 having an average particle size less than about 1.5 microns.

4. The ink composition of claim 1 wherein the onium compound is selected from the group consisting of ammonium cations, phosphonium cations, and combinations thereof.

5. The ink composition of claim 1 wherein the onium compound is formed from oleylamine.

6. The ink composition of claim 1 wherein the onium compound includes primary ammonium cations.

7. The ink composition of claim 1 wherein the onium compound is present in an amount such that 5 mole % to 100 mole % of protogenic groups in the ion-conducting polymer are neutralized.

8. The ink composition of claim 1 wherein the onium compound is present in an amount such that 10 mole % to 50 mole % of protogenic groups in the ion-conducting polymer are neutralized.

9. The ink composition of claim 1 wherein the catalyst and its support are each present in an amount of 1 to 10 weight percent of the total weight of the ink composition.

10. The ink composition of claim 1 wherein the ion conducting polymer is present in an amount of 1 to 20 weight percent of the total weight of the ink composition.

11. The ink composition of claim 1 wherein the ion conducting polymer comprises a PFSA polymer.

12. An ink composition for forming a fuel cell layer, the ink composition comprising:
a solvent system;
an ion-conducting polymer dispersed within the solvent system;
a supported catalyst dispersed within the solvent system; and
a primary ammonium compound including a hydrophobic hydrocarbon moiety selected from the group consisting of C₅-C₃₀ alkyl, C₅-C₃₀ alkenyl, and C₆-C₃₀ aryl.

13. The ink composition of claim 12 wherein the ammonium compound is present in an amount of 0.02 to 5 weight percent of the total weight the composition.

14. The ink composition of claim 12 wherein the ammonium compound is present in an amount of 0.1 to 2 weight percent of the total weight of the ink composition.

15. The ink composition of claim 12 wherein the catalyst and its support are each present in an amount of 3 to 5 weight percent of the total weight of the ink composition.

16. The ink composition of claim 12 wherein the ion conducting polymer is present in an amount of 3 to 10 weight percent of the total weight of the ink composition.

17. The composition of claim 12 wherein the ion conducting polymer comprises a PFSA polymer.

18. A method for making a catalyst layer for a fuel cell, the method comprising:
combining a first liquid composition with an onium compound to form a second liquid composition, the first liquid composition including a solvent system, a supported catalyst, and an ion-conducting polymer, the onium compound including a hydrophobic hydrocarbon moiety; and
forming the catalyst layer from the second liquid composition.

19. The method of claim 18 wherein the hydrophobic hydrocarbon moiety is selected from the group consisting of C₅-C₃₀ alkyl, C₅-C₃₀ alkenyl, and C₆-C₃₀ aryl.

20. The method of claim 19 wherein the onium compound is selected from the group consisting of primary ammonium cations, primary phosphonium cations, and combinations thereof.

21. The method of claim 19 wherein the onium compound comprises a primary ammonium cation.
